(19) United States
(12) Patent Application Publication
(10) Pub. No.: US 2010/0042782 A1
(43) Pub. Date: Feb. 18, 2010

(54) Secure Portable File Storage Device

(76) Inventor: Amiram Grynberg, Neve Efrayim Monoson (IL)

Correspondence Address: AMIRAM GRYNBERG, 24 RIMON ST, NEVE EFRAYIM MONSON, 60190, IL

(21) Appl. No.: 12/542,076

(22) Filed: Aug. 17, 2009

Related U.S. Application Data
(60) Provisional application No. 61/089,566, filed on Aug. 18, 2008.

(51) Int. Cl. G06F 12/14; G06F 12/00

(52) U.S. Cl. 711/115; 711/163; 711/E12.001; 707/9

(57) ABSTRACT

A secure portable file storage device (SPFSD) comprising a controller having at least two control modes, a logical switch and a storage area wherein access level to said storage area is determined by the state of said logical switch and wherein A first control mode permits modifying the state of said logical switch and a second control mode does not permit such modifications; and Entering said first control mode requires first authenticating to said controller; and Said logical switch state is persistent; and Changing a state of a logical switch does not affect the contents of a related storage area.

### CROSS REFERENCE TO RELATED APPLICATIONS

application Ser. 11/748,507 by the same inventor, the benefit of which is hereby claimed under 35 U.S.C. .sctn. 119(e), and wherein said application is further incorporated herein by reference.

Provisional application 61/089,566 by the present inventor the benefit of which is hereby claimed under 35 U.S.C. .sctn. 119(e), and wherein said provisional application is further incorporated herein by reference.

### BACKGROUND OF THE INVENTION

The use of portable file storage devices (PFSD) is proliferating. Such devices take on many shapes: A USB flash drive (UFD), digital camera, cell phone, memory cards, portable computing devices etc.

What is common to all these devices is that their content can be accessed, as file system, by a connected computing device.

application Ser. No. 11/748,507, by the same inventor, discloses a secure portable file storage device incorporating a master switch, wherein said switch controls access permission to said storage device.

Said master switch can hide a storage drive, make it read-only or open it to read-write operations.

However, this not be enough in practice, since users may wish to concurrently hide some of their data, expose other data as read-only and yet another data as read-write.

Take for example the case where a user stores some sensitive and private data on a device wherein access to which should be controlled. At the same time, said user also wants to store pictures on the same device and be able to give that device to a friend for viewing.

Said user may want to hide all sensitive data but to expose non sensitive data for viewing only (read-only).

Thus, it would be advantages if a secure portable file storage device (SPFSD) would be available wherein said device allowed for more granular exposure policy for each storage area independent of the others.

Further, it would be advantageous if a default access level for a non-authenticated user, can be controlled by an authenticated user and said access level persisted within the device so that when a non-authenticated user accesses the device, he or she will only be allowed an access level previously set by an authenticated user.

### SUMMARY OF THE INVENTION

The current invention describes a secure PFSD device (SPFSD) exposing a multiplicity of areas wherein each area can be configured to have its own access level; and methods for controlling said access level.

In accordance with the present invention a single SPFSD exposes a multiplicity of storage drives wherein access to each drive can be controlled by an independent master switch, as disclosed by Ser. No. 11/748,507.

Further, access settings can be persisted to accommodate various default access rights for each exposed drive.

### BRIEF DESCRIPTIONS OF THE DRAWINGS

no drawing.

### DETAILS OF THE INVENTION

The present invention is of a secure portable file storage device SPFSD wherein access privileges to all or part of files and folders stored on such a device are granted by said SPFSD in response to authenticated and non authenticated requests received from applications executing on a hosting computer or on another hosting device.

A hosting device can take a form of a camera, a special jacket or any other computing device that can interface with a portable storage device.

When a SPFSD device is connected to a host computing device, said device exposes each storage area as a storage drive. Thus, said host can, for example, access each area as identified by a drive letter.

Exposing storage areas as drives is well known in the art and is presently used by many commercial devices such as SanDisk Cruzer which exposes a CD drive and read-write drive concurrently.

To facilitate controlled access to each storage area, a logical switch is associated with each area. Said switch controls access level to the whole area as a unit. W use the term switch ‘state’ to designate the position of said switch.

Such a switch, implemented at the controller level of the storage device, can block access to a storage area, effectively making it ‘hidden’, blocking write operations to that are, making it ‘read-only’ or provide for unrestricted access (‘full-access’).

Since a controller is responsible for interpreting all commands sent to a storage device, the switch can be implemented easily at the command interpretation level without affecting other operations.

Modifying access level in this way, does not affect contents within a storage area controlled by said switch. However, the OS has no way of knowing what access level is in effect, thus read-write errors may result when accessing a protected storage area.

Changing a switch logical state, is accomplished by a request sent to the device's controller. However, a controller must be able to control who can change a switch state, otherwise the whole concept falls apart, as anyone could reset the switch to ‘full-access’.

Thus, a controller must authenticate a request before it allows switch changes.

We define two control modes. A first mode is entered by authenticating a request to enter that mode. In said first mode, requests to change switch setting are accepted by a controller. After exiting said first mode, the controller enters a second mode wherein it does not allow modifying switch settings.

Entering and exiting a control mode can be done on a per switching request basis or it can be established as a session wherein entering said first mode requires authentication and exiting said session can be effected by logging out, timeout, powering off the device or other means.

Authenticating a request, can be accomplished in several ways. An effective way is to have a user enter a password to the hosting device, a password that is used by the host to send an authentication request to the SPSFD. However, any method known in the art for establishing authentication between a user and a computing device is acceptable.

Onboard (SPFSD) authentication devices which communicate with the controller are also an option here. Examples for other authentication methods applicable to SPFSD: Fingerprint reader, input means through which a user can enter credentials and mechanical key the presence of which can be sensed by the controller.

However, some times, further controls are required. For example, when an organization has a policy that prohibits changing a switch state when a device is not plugged to a trusted host computer. Thus, a second authentication may be required by a controller, before entering said first mode. Such second authentication, resulting from a policy, can be implemented by using a public-private key pair. A controller is first initialized to recognize certain public keys. Then, during authentication, it requires a host computer to prove knowledge of an associated private key, before it allows switch settings. Other methods known in the art of cryptography are relevant as well.

Once an authenticated control mode is entered, a switch state can be modified thus enabling or disabling certain operations with the device. However, an important feature of the present invention is the ability to persist the state of a switch.

Once a switch state is modified and persisted, exiting the authenticated mode does not reset the switch state. Thus, in accordance with a preferred embodiment of the present invention, a user can change the default behavior of a storage area by modifying the switch's logical state.

This permits, for example the following use case:

A user stores family pictures on a USB storage device. Said user wishes to give said device to a relative so that she can copy pictures from the device. However, our user does not want her to accidentally delete pictures or, to have her computer infect his USB drive with s virus.

To that end, our user plugs the USB device into a host computer, authenticate to the device and modify access level to the storage are to be read-only. Now, when the device is pulled out and given away, it becomes write protected.

A device could have more than a single storage area. This is especially useful when a user has various classes of data he or she wants to store. A first set of data, for example, could be work related data and a second set would be family picture.

We will use the term ‘private’ for the first and ‘public’ for the second.

When plurality of storage areas are available in a single device, a similar mechanism is disclosed by the present invention wherein a separate switch is associated with each storage area providing for independently setting each storage area to a different access level.

Thus, it is now possible to set a first switch related to ‘private’ area to hide work related data (for non-authenticated requests) while setting the second switch related to ‘public’ area, to permit read-only access.

A use case wherein a first user wants to give a device to a second user, but said first user wants to hide work related data and allow only read-only access to public data is accomplished by said first user first authenticating to the device, then setting the state of the switch related to a private area as ‘hidden’, and the switch related to a public area as ‘read-only’. The device can now powered off and given to second user. Having no knowledge of the authentication password for the device, a second user can only view the public area and only in read-only mode.

To facilitate even an easier use, it would be desirable to have a device set its logical switches to states which are determined by the hosting environment (policy).

Thus, we introduce a second authenticated request, wherein once a first authentication is approved, said second request can be automatically invoked by the host to set the state of each switch to a default state desirable for the work profile at that host. Said second request can be authenticated by using digital signatures or other authentication means wherein a device has access to certificates of authorized requestors.

What is claimed is:

1. A secure portable file storage device (SPFSD) comprising a controller having at least two control modes, a logical switch and a storage area wherein access level to said storage area is determined by the state of said logical switch and wherein:
A first control mode permits changing the state of said logical switch and a second control mode does not permit such changes; and
Entering said first control mode requires a first authentication to said controller; and
Said logical switch state is persistent; and
Changing a state of a logical switch does not affect the contents of the related storage area.

2. The device of claim 1 wherein said switch can assume at least 2 states from the following access levels: hidden, read-only, full-access.

3. The device of claim 2 wherein said switch can assume at least 3 states.

4. The device of claim 1 wherein entering said first control mode requires a second authentication in addition to said first authentication.

5. The device of claim 1 wherein said first authentication is implemented by verifying, by said controller, a mechanical feature of a hosting device.

6. The device of claim 1 wherein said first authentication is implemented by a bio authentication sensor means communicative with said controller.

7. The device of claim 1 wherein said first authentication is implemented by user input means communicative with said controller.

8. A secure portable file storage device (SPFSD) comprising a controller having at least two control modes, a plurality of independent logical switches and independent storage areas wherein access level to each storage area is determined by the state of an associated logical switch and wherein:
A first control mode permits changing the state of logical switches and a second control mode does not permit such changes; and
Entering said first control mode requires a first authentication to said controller; and
A logical switch state is persistent; and
Changing a state of a logical switch does not affect the contents of an associated storage area.

9. The device of claim 8 having a first switch and a second switch and associated storage areas wherein the possible states of said first switch are ‘hidden’, ‘full-access’ and the possible states of said second switch are ‘read-only’, ‘full-access’.

10. A secure portable file storage device (SPFSD) comprising a controller having at least two control modes, a plurality of independent logical switches and independent storage areas wherein access level to each storage area is determined by the state of an associated logical switch and wherein:
A first control mode permits changing the state of logical switches and a second control mode does not permit such changes; and
Entering said first control mode requires a first authentication to said controller; and
Logical state of a switch is subsequently determinable by a second authenticated request made by a host device; and
Changing a state of a logical switch does not affect the contents of an associated storage area.
